(19) United States
(12) Patent Application Publication
(10) Pub. No.: US 2019/0363381 A1
(43) Pub. Date: Nov. 28, 2019

(54) Device For The Air Supply Of A Fuel Cell, Preferentially Of A Fuel Cell Operated With Hydrogen

(71) Applicant: MAN Energy Solutions SE, Augsburg (DE)

(72) Inventors: Jan-Christoph HAAG, Hirschberg (DE); Lutz Aurahs, Langweid (DE); Christoph Heinz, Langenau (DE); Klaus Bartholomä, Friedberg (DE)

(73) Assignee: MAN Energy Solutions SE, Augsburg (DE)

(21) Appl. No.: 16/421,030

(22) Filed: May 23, 2019

(30) Foreign Application Priority Data
May 24, 2018 (DE) DE102018112451.1

(51) Int. Cl. H01M 8/04111; H01M 8/04746; H01M 8/22; F04B 25/00

(52) U.S. Cl. CPC H01M 8/04111; F04B 25/00; H01M 8/22; H01M 8/04753

(57) ABSTRACT

A device for the air supply of a fuel cell via two compressor stages, designed with a first compressor of a turbocharger that is drive-effectively connected to a turbine of the turbocharger that can be driven by an exhaust gas flow of the fuel cell, and a supply air supply of the first compressor is connected to the second compressor via an air passage for supplying air compressed by the second compressor.

### BACKGROUND OF THE INVENTION

### 1. Field of the Invention

The invention relates to a device for the air supply of a fuel cell, in particular of a fuel cell operated with hydrogen.

### 2. Description of the Related Art

Conventionally, fuel cells are operated with pure hydrogen in the fuel cell that reacts to form water and in a turbo electricity is released. Usually, the hydrogen is expanded out of a pressure vessel and fed to the fuel cell. The air that is necessary for the combustion in the fuel cell is drawn in from the surroundings by an electrically operated blower and fed to the fuel cell.

A generic prior art is described for example in DE 101 20 947 A1 or in DE 10 2004 051 359 A1.

In both printed documents, two compressor stages are provided and a conventional system bypass branches off after the second compressor stage leading to an inlet of a turbine.

Although this configuration allows a certain regulation of the air supply it does not make possible a necessary degrees of freedom to prevent, for example, in various operating situations that with two compressor stages designed as turbo compressor the desired flow rates and pressures can be energy-efficiently set in the region of the fuel cell.

In the automotive field, fuel cells are also known that are charged by turbochargers. The intake air in this case is drawn in by the compressor of a turbocharger and the exhaust gas generated during the combustion drives the turbine of the turbocharger. If required, additional electric energy can be fed onto the shaft of the turbocharger by an electric motor to offset a thermodynamic imbalance of the two components.

A disadvantage of the known solutions is that the same cannot be energy-efficiently employed for energy generation on an industrial scale. There is a need for increasing the energy efficiency and thus the efficiency of the overall system.

### SUMMARY OF THE INVENTION

An object of one aspect of the invention present here therefore consists in avoiding the mentioned disadvantages and stating a construction which with respect to the flow rates and pressures supplied to the fuel cell offers a high degree of freedom with high energy efficiency at the same time.

A basic idea of the invention consists in making available a two-stage charging system with preferentially an intermediate cooling of the compressed air, wherein one of two compressors of a turbine is driven by exhaust gas of the fuel cell.

According to one aspect of the invention, a device for the air supply of a fuel cell operated with hydrogen is made available via two compressor stages for this purpose, designed with a first compressor of a turbocharger, wherein the compressor is drive-effectively connected to a turbine of the turbocharger that can be driven by an exhaust gas flow of the fuel cell, and a second compressor, wherein a supply air supply of the first compressor is connected to the second compressor via an air passage for supplying the air compressed by the second compressor. The air compressed in this manner via the two compressor stages is supplied to the fuel cell.

In a preferred configuration of the invention a motor, preferentially an electric motor, drives the second compressor (first compressor stage) via a drive shaft or the compressor wheel of the second compressor is directly arranged on the drive shaft. Thus, an electric motor no longer drives the turbocharger but a separate compressor, which is connected upstream of the turbocharger as compressor stage. The compressor connected upstream can thus be directly mounted on the shaft of the electric motor as a result of which the design expenditure can be clearly reduced.

In an alternative configuration of the invention it is provided that on the supply side of the fuel cell a turbine is provided, which is flow-effectively incorporated in the supply for supplying hydrogen to the fuel cell, wherein the turbine is drive-effectively connected to a generator via a shaft and the generator provides electric energy for the motor via an electrical connection line as soon as the generator is driven by the turbine via the shaft.

Alternatively, the energy generated by the generator can be partly or completely provided at the output of the fuel cell in addition to the energy generated by the fuel cell. Complementarily, a control device can also divide the energy between the electric motor and the output on the fuel cell in each case dependent on the respective electrical load as a function of load.

For this purpose, a turbine with a generator is thus used for expanding the hydrogen. Here, the turbine passes its shaft output onto the generator on the shaft of which the turbine is preferentially directly mounted. The electric output can then be either used in order to drive the first compressor or it can be directly coupled to the output of the fuel cell and thus make available additional electric output.

It is advantageously provided, furthermore, when on the supply side on the fuel cell a turbine is provided which is flow-effectively incorporated in the supply for supplying hydrogen to the fuel cell, wherein the turbine is drive-effectively connected to the second compressor via a shaft.

It can likewise be advantageously provided that a cooling device is provided on the air passage between the first and second compressor to cool the compressed air in the air passage, preferentially through the expansion cold generated during the expansion of the hydrogen, which is supplied to the cooling device.

It can likewise be provided that a cooling device is provided on the air passage after the second compressor in order to cool the air compressed by the second compressor in the air passage, preferentially through the expansion cold generated by the expansion of the hydrogen, which is supplied to the cooling device.

In the mentioned embodiment versions it is advantageously provided that the first and second compressor are designed as turbo compressors.

A further aspect of the present invention relates to the use of a device as described above for providing air for a fuel cell, which is part of a fuel cell system, via which electric drive power for a consumer, preferentially in the power range of >100 kW is provided.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Other advantageous further developments of the invention are marked in the subclaims and are presented in more detail by way of the figures in the following together with the description of the preferred embodiment of the invention.

It shows:

FIG. 1 is a schematic diagram of an exemplary embodiment;

FIG. 2 is a schematic diagram of an embodiment; and

FIG. 3 is a schematic diagram of an exemplary embodiment.

### DETAILED DESCRIPTION OF THE PRESENTLY PREFERRED EMBODIMENTS

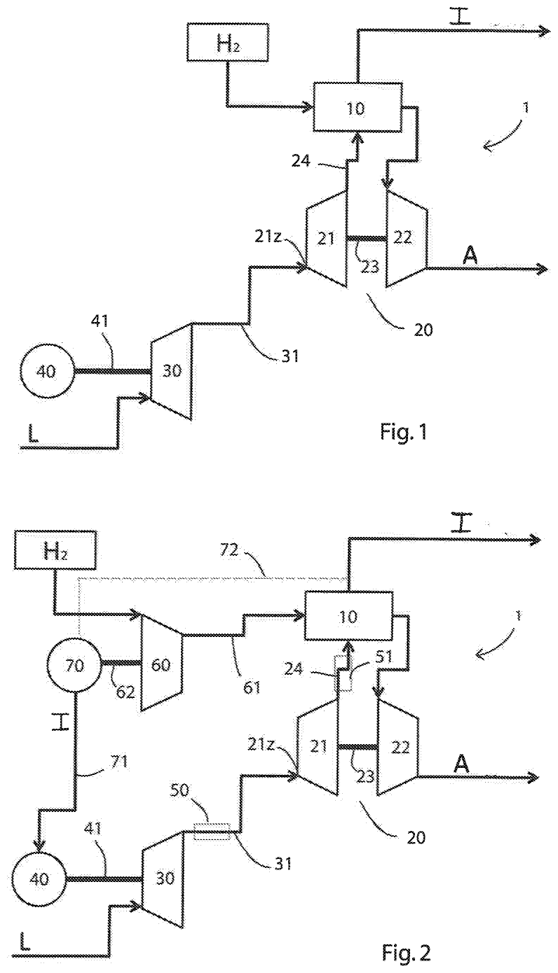

In the following, the invention is described in more detail by way of preferred exemplary embodiments making reference to the FIGS. 1 to 3, wherein same reference numbers in the figures point to same structural and/or functional features.

In the shown exemplary embodiments a fuel cell 10 and the device 1 each for the air supply of the fuel cell 10 operated with hydrogen is shown. The device 1 comprises two compressor stages formed with a first compressor 21 of a turbocharger 20 and a second compressor 30.

The compressor 21 is drive-effectively connected to a turbine 22 of the turbocharger 20 that can be driven by an exhaust gas flow A of the fuel cell 10. The exhaust gas flow generated by the fuel cell 10 flows through the turbine 22 and drives the compressor wheel of the compressor 20 via the shaft 23. Here, the compressed air fed to the compressor 20 by the second compressor 30 is further compressed and via an air supply passage supplied to the fuel cell 10.

Between the two compressors 20, 30 an air passage 31 is arranged so that the air supply 21z of the first compressor 21 is connected to the second compressor 30 via the air passage 31 for supplying the air L compressed by the second compressor 30.

In the exemplary embodiment according to FIG. 2, an electric motor 40 is provided, which drives the second compressor via a drive shaft 41. To this end, the compressor wheel of the second compressor 21 is directly arranged on the drive shaft 41. In this exemplary embodiment it is provided, furthermore, that on the supply side a turbine 60 is provided on the fuel cell which is flow-effectively incorporated into the supply 61 for supplying hydrogen to the fuel cell, wherein the turbine 60 is drive-effectively connected to the generator 70 via the shaft 62.

The generator 70 supplies the motor 40 with electric energy (I) via an electrical connection line 71 as soon as the generator 70 is driven by the turbine 60 via the shaft 62. The energy generated by the generator 70 can be alternatively provided also partly or completely at the output 11 of the fuel cell 10 in addition to the energy generated by the fuel cell 10.

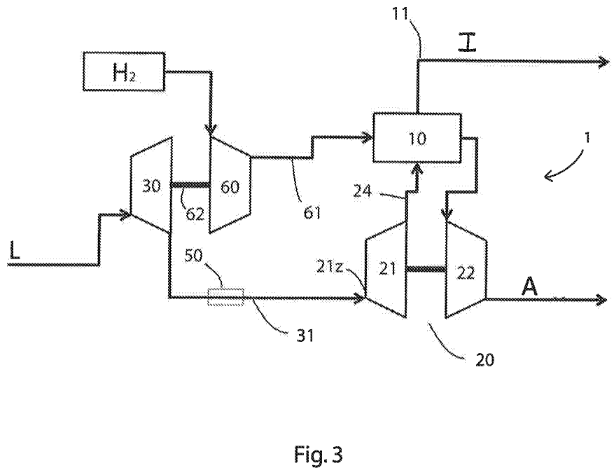

In the embodiment according to FIG. 3, a turbine 60 is provided on the supply side of the fuel cell, which is flow-effectively incorporated in the supply 61 for supplying hydrogen to the fuel cell, wherein the turbine 60 is drive-effectively connected to the second compressors 30 via a shaft 62.

Furthermore, a first cooling device 50 is provided on the air passage 31 between the first and second compressor 20, 30 in order to cool the compressed air in the air passage 31, namely by means of the expansion cold generated during the expansion of the hydrogen, which is supplied to the cooling device 50 via the cooling line located in between.

Furthermore, a further cooling device 51 can be provided on the air passage 22 after the second compressor 20 in order to cool the air compressed by the second compressor 20 in the air passage 22, likewise by means of the expansion cold generated during the expansion of the hydrogen, which can be supplied to the cooling device 51 via a cooling line.

In its embodiment, the invention is not restricted to the preferred exemplary embodiments stated above. On the contrary, a number of versions is conceivable which makes use of the shown solution even with a fundamentally different type of embodiments.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A device configured to supply air to a fuel cell, comprising:
a first compressor of a turbocharger, which is drive-effectively connected to a turbine of a turbocharger that is driven by an exhaust gas flow of the fuel cell;
a second compressor configured to compress air; and
an air passage configured to supply compressed air to the second compressor providing a supply air supply of the first compressor.

2. The device according to claim 1, further comprising:
a motor configured to drive the second compressor via one of:
a drive shaft or
a compressor wheel of the second compressor is directly arranged on the drive shaft.

3. The device according to claim 2, further comprising:
a turbine is provided on a supply side of the fuel cell, which is drive-effectively incorporated in the supply for supplying hydrogen to the fuel cell; and
a generator drive-effectively connected to the turbine via a shaft,
wherein the generator provides electric energy for the motor via an electrical connection line as soon as the generator is driven by the turbine via the shaft.

4. The device according to claim 3, wherein the energy generated by the generator is one of partly and completely made available on an output of the fuel cell in addition to the energy generated by the fuel cell.

5. The device according to claim 1, wherein on a supply side of the fuel cell a turbine is provided, which is flow-effectively incorporated in the supply for supplying hydrogen to the fuel cell, wherein the turbine is drive-effectively connected to the second compressor via a shaft.

6. The device according to claim 1, wherein a cooling device is provided on the air passage between the first and second compressor to cool the compressed air in the air passage.

7. The device according to claim 1, wherein a cooling device is provided on an air passage arranged after the second compressor to cool the air compressed by the second compressor in the air passage.

8. The device according to claim 1, wherein the first and second compressor are turbo compressors.

9. The device according to claim 1, wherein electric drive power is provided for a consumer, in a power range of >100 kW.

10. The device according to claim 1, wherein the fuel cell is operated with hydrogen.

11. The device according to claim 2, wherein the motor is an electric motor.

12. The device according to claim 6, wherein the cooling device utilizes cooling generated during expansion of hydrogen, which is supplied to the cooling device.

13. The device according to claim 7, wherein the cooling device utilizes cooling generated during expansion of hydrogen, which is supplied to the cooling device.
